(19) United States
(12) Patent Application Publication
(10) Pub. No.: US 2007/0268246 A1
(43) Pub. Date: Nov. 22, 2007

(54) ELECTRONIC EQUIPMENT WITH SCREEN PAN AND ZOOM FUNCTIONS USING MOTION

(76) Inventor: Edward Craig Hyatt, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/383,829

(22) Filed: May 17, 2006

(51) Int. Cl. G09G 5/00

(52) U.S. Cl. 345/156

(57) ABSTRACT

An electronic equipment, such as a mobile phone, includes a display for viewing content and/or information, a transducer operable to detect motion of the electronic equipment, and a control circuit for providing information to the display. The control circuit is responsive to detected motion to perform at least one of a pan or zoom of information provided to the display, wherein the pan and/or zoom correspond to a direction and velocity of the detected motion

### TECHNICAL FIELD OF THE INVENTION

The present invention relates generally to electronic equipment and, more particularly, to electronic equipment that includes motion activated pan and zoom functions for viewing a virtual page, and a method of performing motion activated pan and zoom functions on electronic equipment.

### DESCRIPTION OF THE RELATED ART

Conventional mobile phones, in addition to providing voice communication capabilities, also provide a number of non-voice related features. For example, mobile phones can be used to surf the internet, transmit and receive messages (e.g., emails and text messages), play music and videos, take and display photographs, as well as a number of other features. While these features utilize various subsystems of the mobile phone, one subsystem that often is used in all of these features is the display subsystem.

In designing the physical characteristics of mobile phones, a number of considerations are taken into account. Two features of mobile phones that are highly desirable are the size of the mobile phone (generally a smaller phone is preferred) and the viewing area provided by the mobile phone's display (generally a larger viewing area is preferred). However, as the size of the phone is reduced, the size of the display (and thus the viewing area) also is reduced. Conversely, as the viewing area of the display (and thus the display size) is increased, the size of the phone is increased. Consequently, a compromise is reached between the size of the mobile phone and the display viewing area such that satisfactory operation and portability are achieved.

While the above compromise between mobile phone size and display viewing area provides satisfactory operation of the mobile phone, there are some drawbacks. For example, current web pages are formatted for use with conventional computer displays. When such web pages are viewed on conventional mobile phone displays (which are substantially smaller than a computer display), only a portion of the web page can be reasonably viewed on the screen. To view portions not shown on the display, the user must scroll through the web page using the mobile phone's keypad, which can be a slow and tedious process. As a result, special web pages particularly suited for the small displays of mobile phones have been developed. Such web pages, however, typically do not include the content of their larger counter parts.

Similar issues exist for other media viewed on the mobile phone's display. For example, photographs often are taken and/or shared via mobile phones, wherein the photographs are viewed on the mobile phone's display. Often it is desired to zoom in and/or out of the photographic image and/or pan the photographic image on the display. Again, this requires the user to manipulate the mobile phone's keypad. As will be appreciated, such problems can arise for any application that requires use of the mobile phone's display.

In an attempt to address the above issues, motion driven panning of screen displays has been implemented in mobile phones. In such systems, the motion of the mobile phone is correlated to a pan request (e.g., motion to the right indexes the display to the right, motion to the left indexes the display to the left, etc.). While such systems are effective, they do not provide the user with precise control of the pan function. Instead, each motion indexes the display a predetermined amount. For example, if a user wishes to pan right on the display, he must move or “shake” the mobile phone in the right direction, which causes the display to index a predetermined amount to the right (e.g., the image appears to snap or tab over a predetermined distance). The user then must look at the display to determine if the screen shows the desired content. If not, then the user must again move the phone to the right to initiate another pan request, causing the display to again index by the predetermined distance.

### SUMMARY

The present invention enables a mobile phone to easily and intuitively pan and zoom content viewed on the mobile phone's display. A motion sensor, such as an accelerometer or the like, detects motion of the mobile phone (e.g., forward/reverse, sideways, up/down, rotate, etc.). When viewing content on the display, this motion can be translated into pan or zoom functions, such that the user need not manipulate the mobile phone's keypad. Further, the motion of the phone (e.g., direction and velocity) is correlated to a virtual page image such that the pan and/or zoom functions can simulate the movement of a window or magnifying glass over a large document, such as a newspaper, for example. The overall viewing effect is smoother and more precise than using the keypad and/or prior art motion panning systems.

According to one aspect of the invention, there is provided an electronic equipment that includes a display for viewing a virtual page, a transducer operable to detect motion of the electronic equipment, and a control circuit for providing information to the display. The control circuit is responsive to detected motion to perform at least one of a pan or zoom of information provided to the display, wherein the pan and/or zoom correspond to a direction and velocity of the detected motion.

According to another aspect, the transducer is operable to generate a motion signal that corresponds to acceleration and/or deceleration of the electronic equipment, and the control circuit is operable to determine a velocity of the electronic equipment from the motion signal.
According to another aspect, the transducer comprises a signal conditioning circuit to filter out signals representing motion not representative of intended motion of the electronic equipment.

According to another aspect, the signal conditioning circuit comprises a low pass filter.

According to another aspect, the electronic equipment includes a motion signal processing circuit operative to provide a motion signal indicative of duration of the motion, amplitude of the motion, and/or frequency of the motion. The motion signal processing circuit can include at least one of a low pass filter, a threshold detector, an amplitude detector or a frequency detector.

According to another aspect, the transducer comprises an accelerometer, a velocimeter or a signal detector.

According to another aspect, the transducer is operable to detect at least one of acceleration, position, rotation or proximity.

According to another aspect, the detected motion is relative to an orientation of the electronic equipment.

According to another aspect, at least one of the pan or zoom motions is user configurable.

According to another aspect, user configurable pan or zoom motions can include at least one of defining motion along each axis to correspond to a pan or zoom function, and adjusting pan and/or zoom rates.

According to another aspect, the electronic equipment is a mobile phone.

According to another aspect, the electronic equipment is at least one of a personal audio device, a personal video device or a personal digital assistant.

Another aspect of the invention relates to a method of viewing a virtual image on an electronic equipment display, including moving the electronic equipment; detecting such moving; and in response to said moving of a prescribed character; and panning and/or zooming the virtual image on the display, wherein said panning and/or zooming corresponds to a direction and velocity of the detected moving.

Another aspect of the invention relates to panning and/or zooming on the virtual display in proportion to said velocity and direction.

Another aspect of the invention relates to conditioning the detected motion to filter out signals representing motion not representative of intended motion of the electronic equipment.

Another aspect of the invention, the prescribed character of motion includes at least one of acceleration, velocity, direction, directional change or rotation.

Another aspect of the invention relates to enabling or disabling motion detection via a user input.

Another aspect of the invention, enabling or disabling motion detection via a user input includes pressing and holding a key of the mobile phone to enable motion detection.

Another aspect of the invention relates to a computer program operable in electronic equipment, said electronic equipment including a display for viewing information, including code to operate the electronic equipment to detect the character of motion of such electronic equipment, and code for causing information to be panned or zoomed on the display, said panning and/or zooming corresponding to the detected character of motion, wherein said panning and/or zooming corresponds to a direction and velocity of the character of motion.

Another aspect of the invention relates to an electronic equipment that includes a display for viewing a virtual page, a transducer operable to detect motion of the electronic equipment, and a control circuit for providing information to the display. The control circuit is responsive to detected motion to perform at least one of a pan or zoom of information provided to the display, wherein said pan or zoom is substantially continuous with the detected motion.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is schematic illustration of an exemplary mobile phone.

FIG. 2 is a schematic block diagram of a number of exemplary relevant portions of the respective mobile phone of FIG. 1 in accordance with an embodiment of the present invention.

FIGS. 3, 4 and 5 are, respectively, schematic illustrations of exemplary motion transducers providing for motion detection based on threshold, amplitude, or frequency.

FIG. 6A is a schematic diagram illustrating motion of the mobile phone and exemplary interpretations of the motion.

FIG. 6B is a schematic diagram illustrating exemplary panning of an image on a mobile phone display in accordance with the invention.

FIGS. 7A-7C illustrate several views of an exemplary mobile phone display showing a map viewed with different levels of zoom in accordance with the invention.

FIGS. 8A-8B are exemplary signals that may be generated using an accelerometer as the motion sensor.

FIG. 9 is a flow chart representing the exemplary operation of the electronic equipment in accordance with the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” “mobile phone,” “mobile device,” or “mobile terminal” and the like, includes all equipment such as mobile telephones, pagers, communicators, i.e., electronic organizers, personal digital assistants (PDAs), smartphones, portable communication apparatus or the like. The term “electronic equipment” also may include portable digital music and/or video devices, e.g., iPod devices, mp3 players, etc.

In the present application, the invention is described primarily in the context of a mobile phone. However, it will be appreciated that the invention is not intended to be limited to a mobile phone and can be any type of electronic equipment.

An electronic equipment, such as a mobile phone, includes a display for viewing information, such as text messages (e.g., emails), images (e.g., photographs), videos (e.g., movies), menus, web pages, programs, games, etc. Prior to display, such information is stored in a memory of the mobile phone, and is referred to as a virtual page image.

The mobile phone also includes a motion sensor, such as an accelerometer, for example. The motion sensor detects motion of the mobile phone, such as, for example, forward/reverse (z-axis), sideways (x-axis), and up/down (y-axis). The detected motion is provided to a signal conditioning circuit, which analyzes the detected motion to determine whether the motion is intended motion or incidental motion (e.g., a slight bounce from walking or riding in a car). If the motion is determined to be intended motion, the intended motion is provided to a control circuit, which then operates on the virtual page image data so as to pan and/or zoom the display to correspond to the intended motion. More specifically, the control circuit, using data from the motion sensor, determines (or is provided with) a direction and velocity component of the intended motion. The pan and/or zoom functions then are implemented using the direction and velocity components so as to simulate a window or magnifying glass held over a document. In other words, the pan or zoom appears substantially continuous with the intended motion (e.g., pan or zoom, as viewed on the display, appears to directly correspond to the actual motion, as opposed to snapping or tabbing of the image). The control circuit can include a signal conditioner, such as a low pass filter or the like, to enhance the smoothness of the pan and zoom functions.

For example, a virtual page image may represent a document printed on an 8.5″ by 11″ sheet of paper. As the user moves the mobile phone to the right (simulating movement over the virtual page image), the image on the mobile phone's display pans right at a rate and distance corresponding to the actual phone movement. The image presented in the display continuously and smoothly changes with the motion, thereby simulating a window or magnifying glass being scanned over a document.

As will be appreciated, the velocity and direction of motion may be provided to the control circuit by the motion sensor or by another signal conditioning circuit. As used herein, the term “pan” is defined as moving the viewing window up, down, sideways or a combination thereof, to display areas in a data set which, at the current viewing scale, lie outside the viewing window. The term “zoom” is defined as enlarging (zoom in) or decreasing (zoom out) proportionately the size of the display features shown on the computer screen by rescaling the image. Zooming out shows more area with less detail, while zooming in shows less area with more detail.

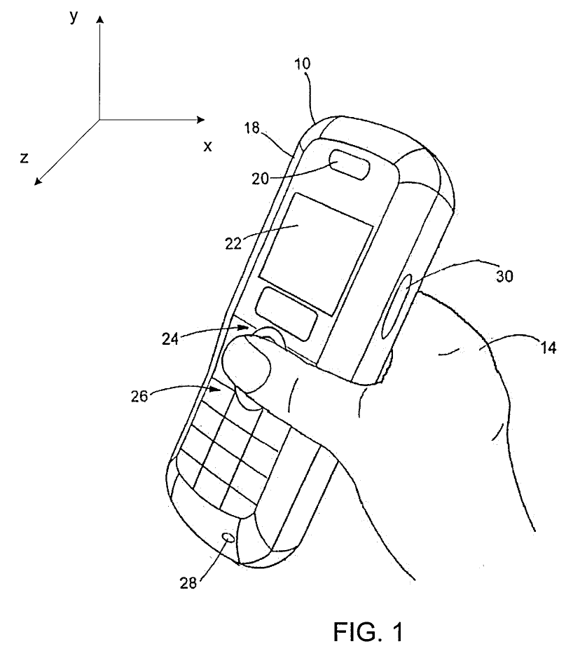

Referring now to FIG. 1, a mobile phone 10 is shown as having a “brick” or “block” design type housing 18, but it will be appreciated that other type housings, such as, for example, claim shell or slide-type housings, may be utilized without departing from the scope of the invention. The mobile phone 10 includes housing 18 (sometimes referred to as a case), speaker 20, display 22, navigation switch and selection/function keys or switches 24, key pad 26, microphone 28, and volume control slide switch 30; these are illustrative and exemplary of parts of a typical mobile phone, but it will be appreciated that other parts that are similar or different in form and/or function may be included in the mobile phone 10. The mobile phones to which the invention pertains also may be of the types that have more or fewer functions, keys, etc., compared to those illustrated and described herein.

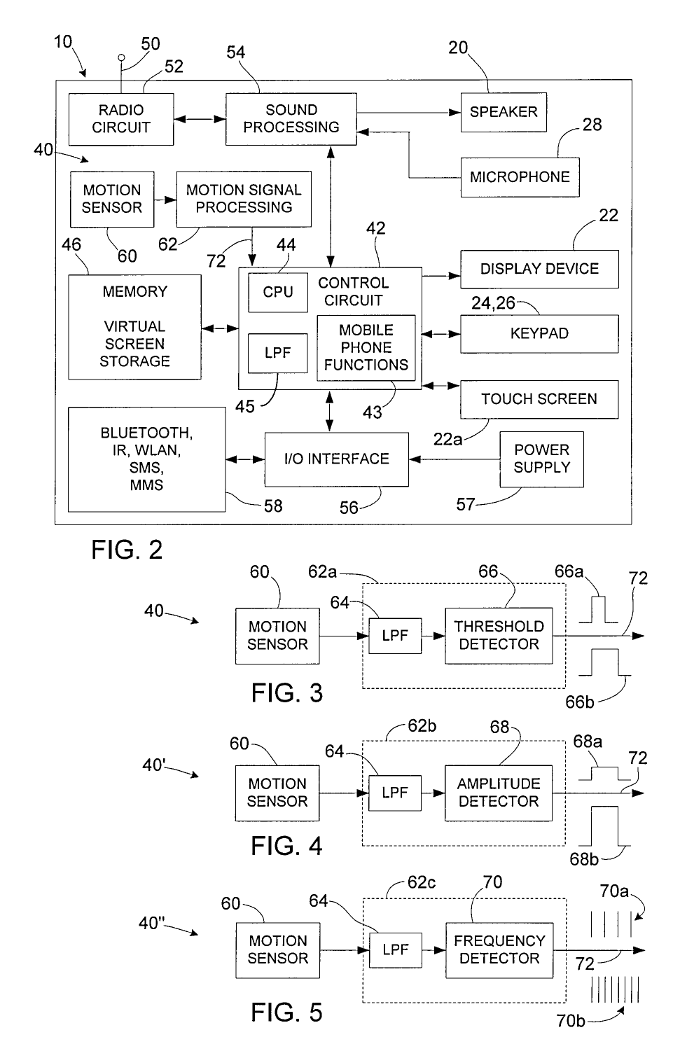

As will be appreciated, the mobile phone 10 may function as a conventional mobile phone. The mobile phone 10 may have additional functions and capabilities that may be developed in the future. From a conventional point of view, the display 22 displays information to a user, such as operating state, time, phone numbers, contact information, various navigational menus, etc., which facilitate and/or enable the user to utilize the various features of the mobile phone. The display also may be used to view movies, images, or to play games, for example. Part or all of the display 22 may be a touch screen type device 22a (FIG. 2). The navigation and function keys 24 and the keypad 26 may be conventional in that they provide for a variety of user operations. For example, one or more of the function keys and navigation device 24 may be used to navigate through a menu displayed on the display 22 to select different phone functions, profiles, settings, etc., as is conventional. The keypad 26 typically includes one or more special function keys, such as, a “call send” key for initiating or answering a call, a “call end” key for ending or hanging up a call, and dialing keys for dialing a telephone number. Other keys included in the navigation and function keys 24 and/or keypad 26 may include an on/off power key, a web browser launch key, a camera key, a voice mail key, a calendar key, etc. The volume control switch 30 may be operated to increase or to decrease the volume of the sound output from the speaker 20. If desired, a sensitivity control also may be provided to change the sensitivity of the microphone 28 as it picks up sounds for transmission by the mobile phone 10. Further, a motion enable/disable key may be implemented as a function key 24 or within the keypad 26, wherein the motion enable/disable key enables or inhibits operation of the motion detection function, as described in more detail below. The mobile phone 10 may have more of fewer keys, navigation devices, etc., compared to those illustrated.

FIG. 2 represents a functional block diagram of an exemplary mobile phone, for example, the mobile phone 10. The representation also is similar to those of PDAs and/or other electronic equipment, as will be appreciated by those having ordinary skill in the art. The construction of the mobile phone 10, which is presented by way of example here, is generally conventional with the exception of the capability provided by a motion transducer 40 and use of information provided by the motion transducer, as described in greater detail below. The various functions carried out by the parts represented in the functional block diagram of FIG. 2 may be carried out by application software within the mobile phone 10. However, it will be apparent to those having ordinary skill in the art that such operation can be carried out via primarily software, hardware, firmware, or a combination thereof, without departing from the scope of the invention.

The mobile phone 10 includes a primary control circuit 42 that is configured to carry out overall control of the functions and operations of the mobile phone 10, e.g., as is represented at block 43. The control circuit 42 may include a CPU 44 (central processor unit), microcontroller, microprocessor, etc., collectively referred to herein simply as CPU 44. The CPU 44 executes code stored in memory within the control circuit 42 (not shown) and/or in a separate memory 46 in order to carry out conventional operation of the mobile phone functions within the mobile phone 10. In addition, the CPU 44 executes code stored in the memory 46, for example, or in some other memory (not shown) in order to perform the various functions of detecting motion based on signals provided by the motion transducer 40 and to alter the display data based on the detected motion. The control circuit 42 also includes a signal conditioner 45, such as a low pass filter, for example. The signal conditioner 45 provides smoothing of the pan or zoom directives during continuous motion of the mobile phone 10.

Continuing to refer to FIG. 2, the mobile phone 10 includes a conventional antenna 50, radio circuit 52, and sound processing signal circuit 54, all of which are cooperative to send and to receive radio frequency (or other) signals in conventional manner. For an incoming signal, for example, the sound processing signal circuit 54 may include an amplifier to amplify the signal and to provide it to the speaker 20 so a user may hear the sound, and the sound processing signal circuit 54 also may use the same amplifier or another amplifier to amplify signals from the microphone 28 for transmitting thereof via the radio circuit 52 and antenna 50 to another mobile telephone, to a cellular phone tower, to a satellite, etc. Operation of the radio circuit 52, sound processing signal circuit 54, speaker and microphone, are under control of the control circuit 42, as is conventional.

The mobile phone 10 includes the display device 22, keypad 24, 26 (including the navigation device mentioned above), and the capability of a touch screen 22a, which may be part or all of the display device 22, and these are coupled to the control circuit 42 for operation as is conventional.

As is illustrated in FIG. 2, the mobile phone 10 includes an input/output interface 56, a power supply 57, and a short distance communications mechanism 58, for example a Bluetooth communications device, infrared (IR) communications device, or some other device. Another example of a short distance communications mechanism is wireless local area network (WLAN), and the invention also may use still other short distance communications mechanisms or devices that currently exist or may be developed in the future. The short distance communications mechanism 58 may transmit and receive signals using SMS (short message service), MMS (multimedia messaging service) or some other communications mechanism and protocol. Bluetooth, IR, WLAN communications for communicating over short distances between mobile phones are well known; other mechanisms may exist and/or may be developed in the future, and these may be utilized by and are included for use in the invention.

With further reference to FIGS. 3, 4 and 5, several examples of motion transducers 40, 40′ and 40″ are illustrated. The motion transducer 40 shown in FIG. 3 includes a motion sensor 60, for example, an accelerometer or an acceleration transducer. The motion transducer 40 also may include signal processing circuitry, for example, motion signal processing circuit 62, which is described below. An accelerometer may provide a signal output, e.g., an electrical signal, representing acceleration of the transducer. The accelerometer may be in the case or housing 18 of the mobile phone 10. An accelerometer is useful to produce signals representing motion occurring as a user rotates or moves the mobile phone sideways, forward/reverse or up/down while holding the mobile phone in the hand 14. The transducer may be a position sensor type transducer or a rotation sensing transducer, either of which may provide a signal output, e.g., an electrical signal that represents the motion of or changes in location or orientation of the mobile phone. Still another example of a transducer may be a proximity sensor, whereby the sensor provides a signal output representing the proximity of the mobile phone to another object.

It will be appreciated that a motion transducer may be any device, circuit or other mechanism or combination thereof that provides an indication that motion has been sensed and/or provides an indication of the character of the motion, such as, for example, acceleration, velocity, direction, directional change, rotation, or any other characterization of the motion. An example, as is mentioned above, is an accelerometer that provides an electrical output (or some other output) in response to acceleration. Another example is a velocimeter that provides an output representative of velocity. Still another example is a signal detector that responds to changes in electrical signals, radio frequency signals, or some other signals, such as amplitude or frequency or changes therein, Doppler shift, or some other discernible change that occurs due to motion.

The motion transducer 40, as is shown in respective embodiments of FIGS. 3, 4 and 5, also includes a motion signal processing circuit, which is designated generically 62 in FIG. 2 and is designated individually 62a, 62b, 62c, respectively, in FIGS. 3, 4 and 5. The motion sensor 60 produces an output indicative of motion of the mobile phone 10. This output is provided to the motion signal processing circuit 62 that processes and conditions the signal prior to being input to the control circuit 42. For example, the motion signal processing circuit 62 provides a motion signal to the control circuit 42 to indicate at least one of that motion has been detected, characteristics of that motion, e.g., duration of the motion, amplitude of the motion, frequency (e.g., changes of direction) of the motion, etc. and/or that motion has ceased. The motion signal processing circuit 62 may filter the output of the motion sensor 60 or otherwise may condition the output using known techniques such that the indication of motion or an appropriate signal to represent motion to the control circuit 42 only is provided in instances where the user decidedly moves the mobile phone 10 in a prescribed manner, e.g., in a back and forth or up and down motion or in some other prescribed manner. Such motion is referred to as intended motion. The motion signal processing circuit 62 may block from the control circuit 42 signals representing brief or casual movement of the mobile phone 10, e.g., a dead zone where slight movement of the phone, such as a result of being carried by a user while walking, bouncing in a moving car, etc., is not registered as an intended motion Therefore, the motion signal processing circuit 62 preferably requires that the output from the motion sensor 60 be maintained for at least a predetermined time, amplitude and/or frequency prior to issuing a motion indication, e.g., that intended motion has been detected, to the control circuit 42. Alternatively, the motion signal processing circuit 62 may provide inputs to the control circuit 42 and the control circuit 42 may include appropriate circuitry and/or program code to effect the desired filtering, e.g., as was just described, to avoid false indications of motion detection of a type that would result in panning and/or zooming, for example. Further, the motion signal processing circuit 62 may be enabled or disabled via function keys 24 and/or the key pad 26. For example, if the user desires to pan or zoom the image presented on the display 22, the user first presses and holds the motion enable key (e.g., a preprogrammed function key), which enables the motion signal processing circuit 62. If the key is released, the motion signal processing circuit 62 is disabled, and any motion of the mobile phone 10 will have no effect on the displayed image.

With the above in mind, then, each of the exemplary motion signal processing circuits 62a, 62b, 62c shown in FIGS. 3, 4 and 5 includes a low pass filter 64 and either a threshold detector 66, amplitude detector 68 or frequency detector 70. In an another embodiment the motion signal processing circuit may include a combination of two or more of the detectors 66, 68, 70. The low pass filter 64 removes or blocks signals representing casual motion or noise or spurious signals representing brief, unintended movement of the mobile phone 10 or casual movement of the mobile phone, such as may occur during walking or bouncing in a moving vehicle. The threshold detector 66 is designed to output an appropriate motion signal on line 72, which is coupled as an input to the control circuit 42, when motion of a relatively long duration occurs, e.g., probably not due to casual motion, noise or the like. In response to such motion signal the control circuit 42 effects operation of the mobile phone 10 to pan or zoom the display. The threshold detected by the threshold detector 66 may be represented by pulse width of signals input thereto, and the output therefrom may be representative of such pulse width, as is represented by the relatively short and long pulse width signals 66a, 66b. The signal provided on line 72 to the control circuit 42 may be of a shape, form, duration, etc., similar to the signals 66a, 66b, may be respective high or low signals, depending on the duration of the signals 66a, 66b, may be a digital signal value of a prescribed number of data bits in length, or may be of some other character that is suitable to effect a desired operation of the control circuit 42 depending on whether or not intended motion that is to cause panning or zooming has been detected. As several examples, the cutoff or distinguishing duration of pulse widths representing the motion detected to distinguish between intended motion and casual motion or noise may be from about a fraction of a second to up to three or four seconds; these are just exemplary and the duration or pulse width of occurrence of such motion may be more or less.

As another example of motion signal processing circuit 62b, there is illustrated in FIG. 4 a low pass filter 64 and an amplitude detector 68. The amplitude detector 68 provides an output on line 72, e.g., of a type suitable for the control circuit 42 to understand and to operate based on whether intended or prescribed motion has been detected or has not been detected. For example, casual motion or noise may produce a relatively low amplitude signal 68a as input or output from the amplitude detector; and intended or prescribed motion may produce a relatively larger amplitude signal 68b as input or output to/from the amplitude detector 68.

Still another example of motion signal processing circuit 62c is illustrated in FIG. 5 as a low pass filter 64 and a frequency detector 70. The frequency detector 70 provides an output on line 72, e.g., of a type suitable for the control circuit 42 to understand and to operate based on whether intended or prescribed motion has been detected or has not been detected. For example, casual motion or noise may produce a relatively low frequency signal 70a or respond to a relatively low frequency signal 70a, respectively, as output from or input to the amplitude detector. A relatively higher frequency signal 70b input to and/or output from the frequency detector 70 representing detection of intended motion, may be provided to the control circuit 42.

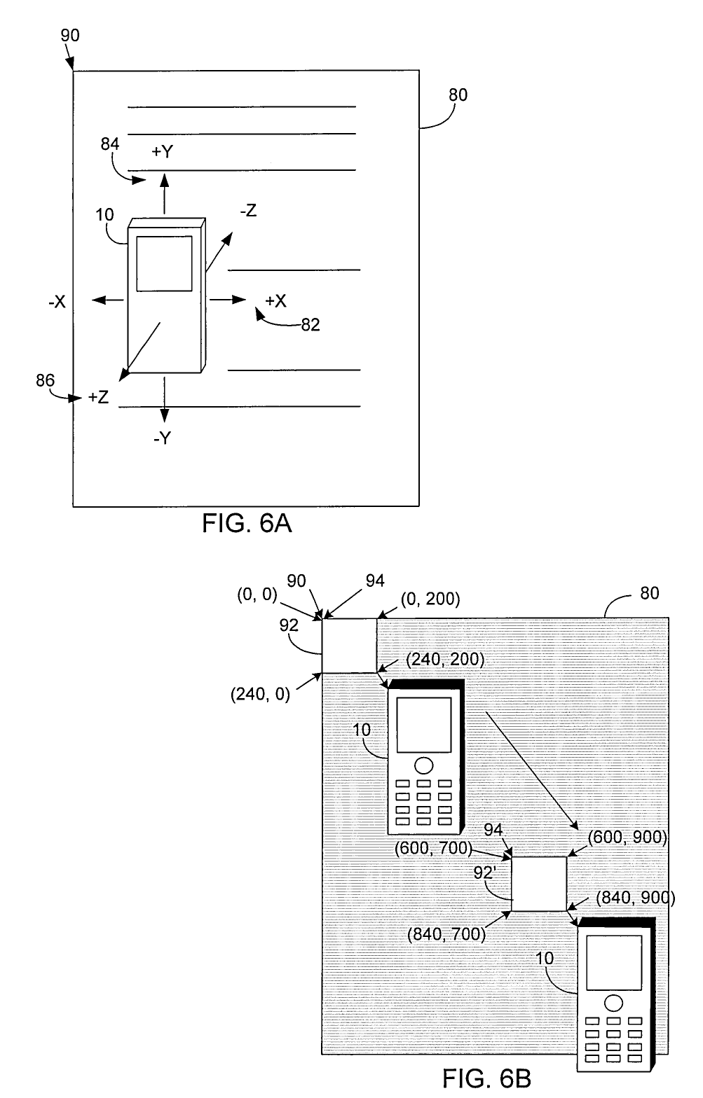

If the motion signal processing circuit 62 detects intended motion as described herein, the intended motion is provided to the control circuit 42. Referring to FIG. 6A, there is shown the mobile phone 10 relative to a virtual page image 80, wherein sideways motion (e.g., the x-axis) 82 can be interpreted as a request to pan the display left (-x direction) or right (+x direction), while up/down motion (e.g., the y-axis) 84 can be interpreted as a request to pan the display up (+y direction) or down (−y direction). Motion in a forward/reverse or in/out direction (the z-axis) 86 can be interpreted as a request to zoom into an image (−z direction) or zoom out from an image (+z direction), it is noted that all motion along the x, y and z axes is relative to the mobile phone, such as a plane of the mobile phone's display 22, for example. Thus, the mobile phone's physical orientation does not affect interpretation of the requested functions. A user lying on his back moving the mobile phone upward in real space (vertical movement) has the same effect as a user standing on his feet moving the mobile phone away from him (horizontal movement). Both will experience a “zoom in” function (assuming movement away from the user is defined as zoom in).

The interpreted motion may be user programmable, such that a user can adjust or change motion about one or more axes so as to perform actions other than described above (e.g., +y direction may be configured as a pan down request, or as a zoom in request, etc.). Further, the pan and/or zoom rate also may be user definable so as to enable each user to setup the motion parameters to their liking. For example, the user may define the relative change of magnification and/or the relative change in position with respect to the virtual page image based on the amount of motion. The system can be configured such that short motion results in a large zoom (or pan) or little zoom (or pan). Further, the motion can be scaled such that fast motion is interpreted as a high rate of zoom (or pan), while slow motion is interpreted as a slow rate of zoom (or pan).

Based on the intended motion signal as detected by the motion signal processor 62, the control circuit 42 can access memory 46 to retrieve, operate on, and/or store data relating to the virtual page image 80. For example, the virtual page image 80 stored in memory 46 can have a predetermined size (e.g., 1000 pixels by 1200 pixels) that is generally larger than the display's viewing area, and a location 90 in the virtual page image 80 can be given pre-defined coordinates (e.g., a left-most corner of the virtual page image can be defined as the point (0, 0), which also is referred to as the origin 90), wherein all points in the virtual page image 80 can be referenced relative to the origin 90. Additionally, and with further reference to FIG. 6B, the display 22 is configured so as to enable an image having predefined size (e.g., 200 pixels by 240 pixels) to be displayed thereon, and a reference point 94 is defined as the point in the upper most left corner of the display 22 (i.e., an origin of the display 22). The first image 92 is shown having a reference point 94 that corresponds to the origin 90 of the virtual page image 80. Thus, the first image 92 on the display 22 according to the present example corresponds to virtual page image defined by the rectangle having corners at (0, 0), (240, 0) (0, 200) and (240, 200). As the user moves the mobile phone 10 in the +x direction 82 and −y direction 84 (e.g., requesting a pan right and down), the motion sensor 60 detects the motion and provides data to the motion signal processing circuit 62, which determines if the motion is intended motion or incidental motion. If the motion is incidental motion, the image provided on the display remains unchanged. However, if the motion is intended motion, then the data corresponding to the intended motion is provided to the control circuit 42, which proceeds to change the reference point 94 of the display 22. As the reference point 94 is changed, a new image 92′ is shown in the display 22 (e.g., the motion is translated relative to the virtual page image to show a different portion of the virtual page image). For example, if the reference point is changed from (0, 0) to (600, 700) (e.g., in response to a fast downward motion to the right), then the image on the display 22 corresponds to the virtual image data defined by the rectangle having corners at (600, 700), (840, 700), (600, 900) and (840, 900). Changes to the reference point 94 of the display 22 can be made in smaller increments to provide a smoother scrolling action. Further, the coordinate system as well as the units for describing image size are merely exemplary and other systems may be used without departing from the scope of the invention.

Zoom functionality can be implemented by designating an amount of data to be displayed in the viewing area of the mobile phone's display 22, and fitting or resealing that data to the available display area. For example, a current or default view on the mobile phone's display 22 may directly correspond to the virtual page image 80 (e.g., a 1:1 relationship), wherein information on the display 22 is shown having the resolution of the virtual page image 80. Since the virtual page image 80 is larger than the viewing capability of the display 22, only a portion of the virtual page image may be viewed at any one time. If the user moves the mobile phone 10 in the +z direction (zoom out), the relationship between the image data viewed on the mobile phone 10 relative to the virtual page image 80 may be reduced (e.g., 1:2), thereby enabling more information to be viewed on the mobile phone's display 22 at a lower resolution. Conversely, if the user moves the mobile phone 10 in the −z direction (zoom in), the relationship between the image data viewed on the mobile phone's display 22 relative to the virtual page image 80 may be increased (e.g., 2:1), thereby enabling less information to by viewed on the display 22 at a higher resolution.

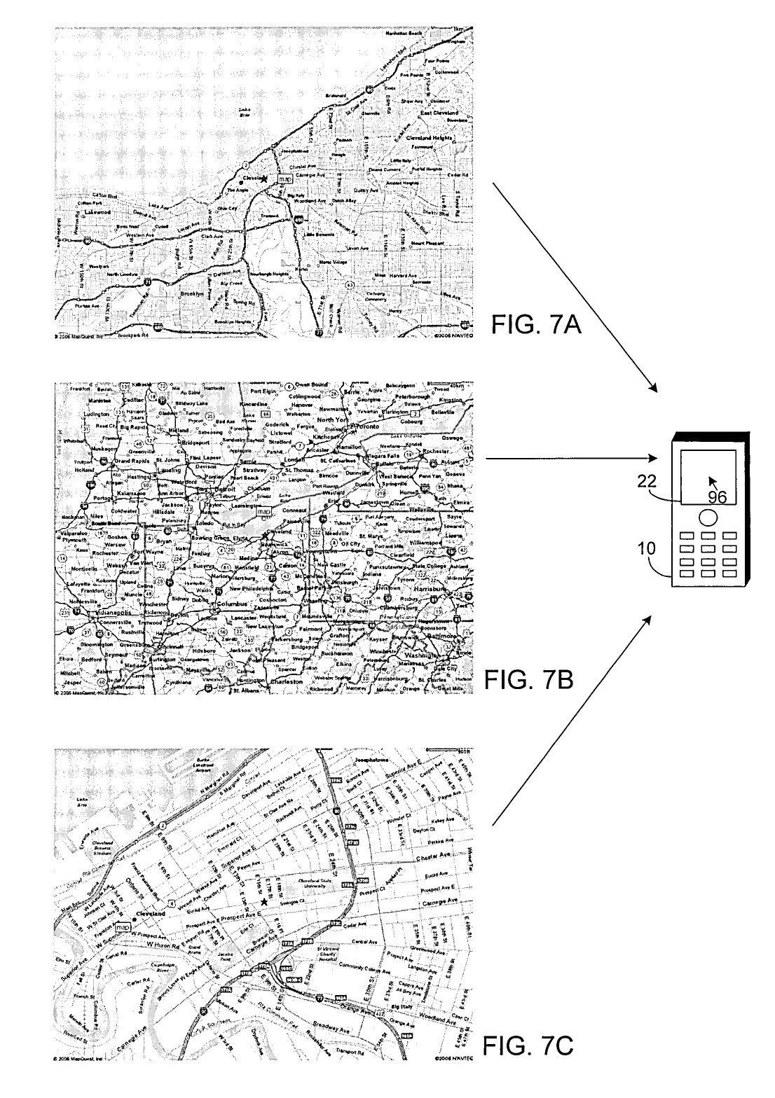

FIGS. 7A-7B are exemplary displays of a road map a map having different levels of zoom. FIG. 7A illustrates a non-zoomed view (e.g., a 1:1 relationship) of the map as it may appear in the display 22 of the mobile phone 10, wherein the non-zoomed view corresponds to a city view (e.g., the user can view major streets and/or highways of a city, but not minor streets). If the user wishes to view another city within the country, the user can use the pan function as described above. Alternatively, the user may move the mobile phone in the +z direction (zoom out) to obtain a view of an entire region (e.g., a 1:2 relationship), such as the Midwest, East Coast, etc., as shown in FIG. 7B. This zoomed out view enables the user to view a number of cities on the display 22 (e.g., a larger viewing scope), although the level of detail will be substantially lower (e.g., only major interstates may be shown). Using this view, the user can select another city in the region by using the pan function to center the desired city on the display 22 and then move the mobile phone 10 in the −z direction (e.g., zoom in). This will bring the user back to the city view for the new city. Again, the user may use the pan function to move about the city view. If the user wishes to obtain further detail regarding streets and/or landmarks (e.g., a smaller viewing scope having enhanced detail), the user may again move the mobile phone 10 in the −z direction to further zoom into the map (e.g., a 2:1 relationship), thereby showing further detail regarding minor streets, etc., as shown in FIG. 7C. In all cases, the image data fills the entire display 22 regardless of the zoom rate, the only difference between views being the scope of the information shown and the level of detail of that information. Further, it is noted that the above relationships (e.g., 1:1, 2:1, 1:2) are merely exemplary and any ratio may be implemented without departing from the scope of the invention.

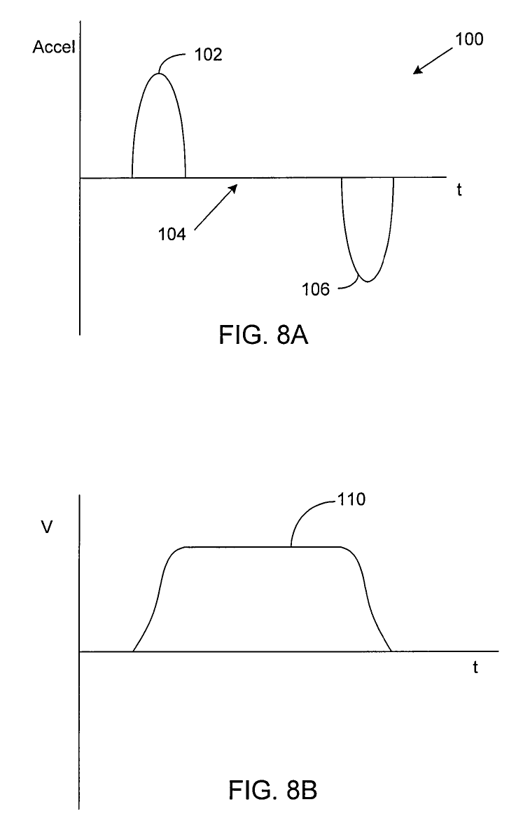

Referring now to FIG. 8A, there is shown an exemplary signal 100 that may be generated by a motion sensor 60 embodied as an accelerometer. Initially, the mobile phone 10 (and thus the accelerometer) is assumed to be at rest, and at some time tᵢ later, the mobile phone is moved. The acceleration of the mobile phone 10 is detected by the accelerometer, which generates a first pulse 102 during the acceleration period. As can be seen, the first pulse 102, which is non-linear, represents variable acceleration of the mobile phone 10. As will be appreciated, constant acceleration may be represented by linear functions (e.g., a triangular pulse). At some time tᵢ₊ₙ later, acceleration is no longer detected, which is indicated by no signal activity in the region 104 between the first pulse 102 and a second pulse 106. During this period, and the control circuit 42 presumes that motion is continuing at a stead state velocity, as described below. At some time tᵢ₊₃ₙ later, the accelerometer detects deceleration and generates the deceleration pulse 106, and at tᵢ₊₄ₙ, motion of the mobile phone 10 is no longer occurring. As will be appreciated by those skilled in the art, the signals generated by the motion sensor 60 may take other forms based on the type of motion sensor employed in the mobile phone 1, and the single of FIG. 8A is merely exemplary.

With further reference to FIG. 8B, there is shown an exemplary velocity profile 110 that may be generated by the control circuit 42 in response to the data from the accelerometer. The velocity profile 110 can be generated, for example, by integrating the acceleration and deceleration as detected by the accelerometer with respect to time. As can be seen in FIG. 8B, the control circuit 42, based on the integral of the acceleration, presumes that the mobile phone 10 is moving at a constant velocity during the period between the first pulse 102 (the acceleration pulse) and the second pulse 104 (the deceleration pulse). Using the direction and velocity of motion, the control circuit 42 pans and/or zooms the display in a direction and at a rate that corresponds to the direction and velocity of the detected motion.

A person having ordinary skill in the art of computer programming and applications of programming for mobile phones would be able in view of the description provided herein to program a mobile phone 10 to operate and to carry out the functions described herein. Accordingly, details as to the specific programming code have been omitted for the sake of brevity. Also, while software in the memory 46 or in some other memory of the mobile phone 10 may be used to allow the mobile phone to carry out the functions and features described herein in accordance with the preferred embodiment of the invention, such functions and features also could be carried out via dedicated hardware, firmware, software, or combinations thereof, without departing from the scope of the invention.

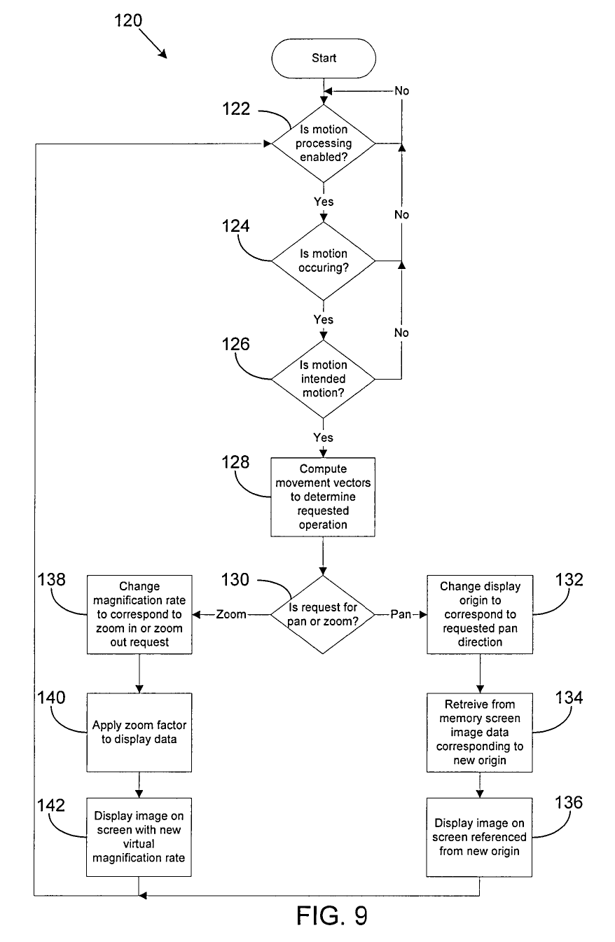

FIG. 9 illustrates a representative flow chart 120 showing an example of steps, functions and methods that may be carried out using the invention. The flow chart includes a number of process blocks arranged in a particular order. As should be appreciated, many alternatives and equivalents to the illustrated steps may exist and such alternatives and equivalents are intended to fall within the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

The steps shown in the flow chart may be carried out using a mobile phone, for example, of the type described herein or other type. Appropriate programming code may be written in an appropriate computer language or the like to carry out the steps, functions and methods as now are described with respect to FIG. 9. The steps shown in the flow chart are referred to below as blocks.

Beginning at block 122, it is determined whether motion processing is enabled in the mobile phone 10. If motion processing is not enabled, then images provided to the display 22 will not be panned or zoomed as the mobile phone is moved. Motion processing can be enabled, for example, by setting a parameter within the phone (e.g., via a soft menu located within the phone's setup and configuration utility) or by using one or more keys (e.g., via function keys 24 or keypad 22) on the mobile phone to enable and disable motion processing. For example, motion processing may be enabled when a specific key is depressed or key stroke is entered into the mobile phone 10, and disable when the key is released or a different keystroke is entered. If motion processing is not enabled, then the method moves back to block 122 and the process repeats. If motion processing is enabled, then the method moves to block 124.

At block 124, it is determined whether the phone is moving (e.g., in an up/down, sideways or back and forth manner). Motion can is detected by the motion sensor 60 in conjunction with the motion signal processing circuitry 62. For example, the motion sensor 60 may be a three axis accelerometer that produces voltage signals indicative of acceleration along any of the three axes. The acceleration signal may be presented as a signed digital value, wherein the magnitude is the calculated acceleration, and the acceleration direction is indicated by the sign. The vector sum of the three signed values corresponds to the motion of the mobile phone 10. As will be appreciated, form and/or derivation of the motion signal may be different for different types of motion sensors. If the vector sum of the motion signal is at or near zero (e.g., within a dead band around 0), then motion is not occurring, and the method moves back to block 122. However, if the vector sum is not zero (or not within the dead band), then it is concluded that motion is occurring and the method moves to block 126.

At block 126, the motion is analyzed to determine if the motion is intended motion. As described herein, the threshold detector 66, amplitude detector 68 and/or frequency detector 70 determine whether such motion is intended motion or unintended motion (e.g., incidental motion due to walking or slight bouncing in a car). Determination of whether or not the motion is intended motion can be based on a comparison of the detected motion relative to a threshold value. For example, if the detected motion signal is slowly oscillating between a first value and a second value, wherein the first and/or second values are outside the above-mentioned dead zone, such motion may be interpreted as unintended motion if the oscillation frequency is low (e.g., motion due to an unsteady hand, slight bounce due to walking, etc.) even though motion actually is occurring. If the detected motion is determined to be unintended motion, then the method moves back to block 122. If the detected motion is determined to be intended motion, then the method moves to block 128.

At block 128, the movement vectors are computed to determine direction and velocity of the motion. Movement along any of the three axes can be interpreted as specific requests to pan and/or zoom. For example, movement in the +y direction can be interpreted as a request to pan up the virtual document, while movement in −y direction can be interpreted as a request to pan down the virtual document. Other directions can be interpreted in a likewise manner (e.g., +x direction may be a request to pan right, −x direction may be a request to pan left, +z direction may be a request to zoom out, and −z direction may be a request to zoom in). As discussed herein, the specific assignments for the different vectors may be redefined by the user.

As will be appreciated, processing of the specific signals is dependent on the type of sensor used to detect motion. For example, an accelerometer can detect acceleration and deceleration, but cannot detect constant motion with zero acceleration or deceleration. Thus, additional signal processing may be implemented within the motion signal processing circuit 62 and/or the control circuit 42 to fully interpret the actual motion. For example, constant or steady state motion may be inferred after a period of acceleration without deceleration. The motion signal processing circuit 62 and/or the control circuit 42 may look at the start of motion (e.g., acceleration) and calculate an estimated velocity as the integral of acceleration/deceleration. Periods of no acceleration/deceleration may be interpreted as constant motion at the estimated velocity.

Based on the computed movement vectors, it is determined at block 130 whether a pan request or a zoom request (or both) have been made by the user. If the request is a pan request, then the method moves to block 132 and the mobile phone display reference point 94 is changed so as to affect a shift of the virtual page image 80. For example, if the mobile phone reference point 94 is the same as the origin of the virtual page image (e.g., they are both 0, 0), and a user subsequently makes a pan right request, the control circuit 42 can alter the mobile phone reference point 94 to be offset from the virtual page origin (e.g., the x-component of the display reference point 94 can be incremented, such as to 1, 0). Then at block 134, the virtual page image data is retrieved from memory 46 using the new reference point 94, and at block 136 the image is refreshed on the display 22. The new reference point 94 causes the image to shift right, thereby providing a pan right function. As will be appreciated, pan left is similar to pan right, except the x coordinate is decremented instead of incremented. Panning up or down operates on the y-coordinate, instead of the x-coordinate. Upon the new image being refreshed on the display, the method moves back to block 122.

Moving back to block 130, if a zoom request has been made, the method moves to block 138 and the magnification rate is increased (zoom in) or decreased (zoom out) corresponding to the requested action. The zoom values modify the magnification factor that the control circuit 42 applies to the data when displaying the virtual image page. At block 140 the virtual page image data is modified using the new zoom factor, and at block 142 the image is refreshed on the display 22.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electronic equipment, comprising:
a display for viewing a virtual page;
a transducer operable to detect motion of the electronic equipment; and
a control circuit for providing information to the display, wherein the control circuit is responsive to detected motion to perform at least one of a pan or zoom of information provided to the display, wherein the pan and/or zoom correspond to a direction and velocity of the detected motion.

2. The electronic equipment of claim 1, wherein the transducer is operable to generate a motion signal that corresponds to acceleration and/or deceleration of the electronic equipment, and the control circuit is operable to determine a velocity of the electronic equipment from the motion signal.

3. The electronic equipment of claim 1, said transducer comprising a signal conditioning circuit to filter out signals representing motion not representative of intended motion of the electronic equipment.

4. The electronic equipment of claim 3, said signal conditioning circuit comprising a low pass filter.

5. The electronic equipment of claim 1, further comprising a motion signal processing circuit operative to provide a motion signal indicative of duration of the motion, amplitude of the motion, and/or frequency of the motion.

6. The electronic equipment of claim 5, wherein the motion signal processing circuit includes at least one of a low pass filter, a threshold detector, an amplitude detector or a frequency detector.

7. The electronic equipment of claim 1, said transducer comprising an accelerometer, a velocimeter or a signal detector.

8. The electronic equipment of claim 1, said transducer operable to detect at least one of acceleration, position, rotation or proximity.

9. The electronic equipment of claim 1, wherein the detected motion is relative to an orientation of the electronic equipment.

10. The electronic equipment of claim 1, wherein at least one of the pan or zoom motions is user configurable.

11. The electronic equipment of claim 10, wherein user configurable includes at least one of defining motion along each axis to correspond to a pan or zoom function; and adjusting pan and/or zoom rates.

12. The electronic equipment of claim 1, wherein said electronic equipment is a mobile phone.

13. The electronic equipment of claim 1, wherein said electronic equipment is at least one of a personal audio device, a personal video device or a personal digital assistant.

14. A method of viewing a virtual image on an electronic equipment display, comprising:
moving the electronic equipment;
detecting such moving; and
in response to said moving of a prescribed character, panning and/or zooming the virtual image on the display, wherein said panning and/or zooming corresponds to a direction and velocity of the detected moving.

15. The method of claim 14, further comprising panning and/or zooming on the virtual display in proportion to said velocity and direction.

16. The method of claim 14, further comprising conditioning the detected motion to filter out signals representing motion not representative of intended motion of the electronic equipment.

17. The method of claim 14, said prescribed character including at least one of acceleration, velocity, direction, directional change or rotation.

18. The method of claim 14, further comprising enabling or disabling motion detection via a user input.

19. The method of claim 18, wherein enabling or disabling motion detection via a user input includes pressing and holding a key of the mobile phone to enable motion detection.

20. A computer program operable in electronic equipment, said electronic equipment including a display for viewing information, comprising:
code to operate the electronic equipment to detect the character of motion of such electronic equipment; and
code for causing information to be panned or zoomed on the display, said panning and/or zooming corresponding to the detected character of motion, wherein said panning and/or zooming corresponds to a direction and velocity of the character of motion.

21. An electronic equipment, comprising:
a display for viewing a virtual page;
a transducer operable to detect motion of the electronic equipment; and
a control circuit for providing information to the display, wherein the control circuit is responsive to detected motion to perform at least one of a pan or zoom of information provided to the display, wherein said pan or zoom is substantially continuous with the detected motion.
